(19) United States
(12) Patent Application Publication
(10) Pub. No.: US 2006/0199074 A1
(43) Pub. Date: Sep. 7, 2006

(54) Linearly growing polymer-based thin film under an applied electric potential

(76) Inventors: Andre Pascal Ngankam, New Haven, CT (US); Paul Robert Van Tassel, New Haven, CT (US)

Correspondence Address: Dr. Andre P Ngankam, 24 Concord Street, Hamden, CT, 06514, US

(21) Appl. No.: 11/218,160

(22) Filed: Sep. 1, 2005

Related U.S. Application Data
(60) Provisional application No. 60/606,801, filed on Sep. 2, 2004.

(51) Int. Cl. H01M 2/16

(52) U.S. Cl. 429/137; 427/58

(57) ABSTRACT

The present invention consists of a process for growing polymer and protein films onto electrode surfaces from aqueous solutions. In this process, following an initial transient period, the growth is linear in time for an applied anodic potential exceeding a threshold value. (Henceforth we refere to this phenomenon as “continuous growth under an electric potential”, or CGE). This invention is also related to the films obtained using this method.

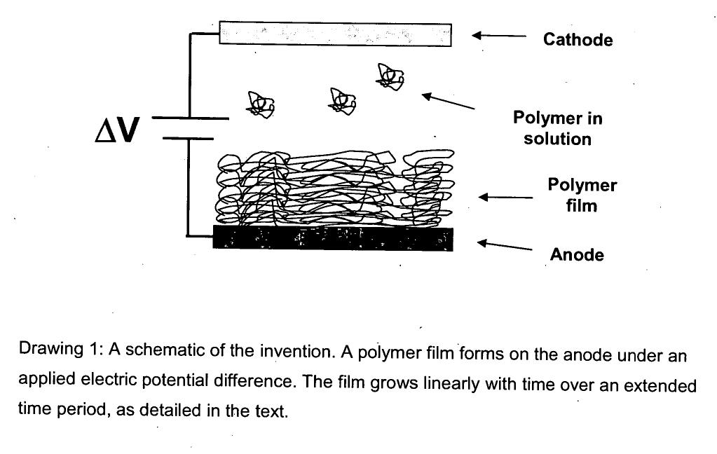

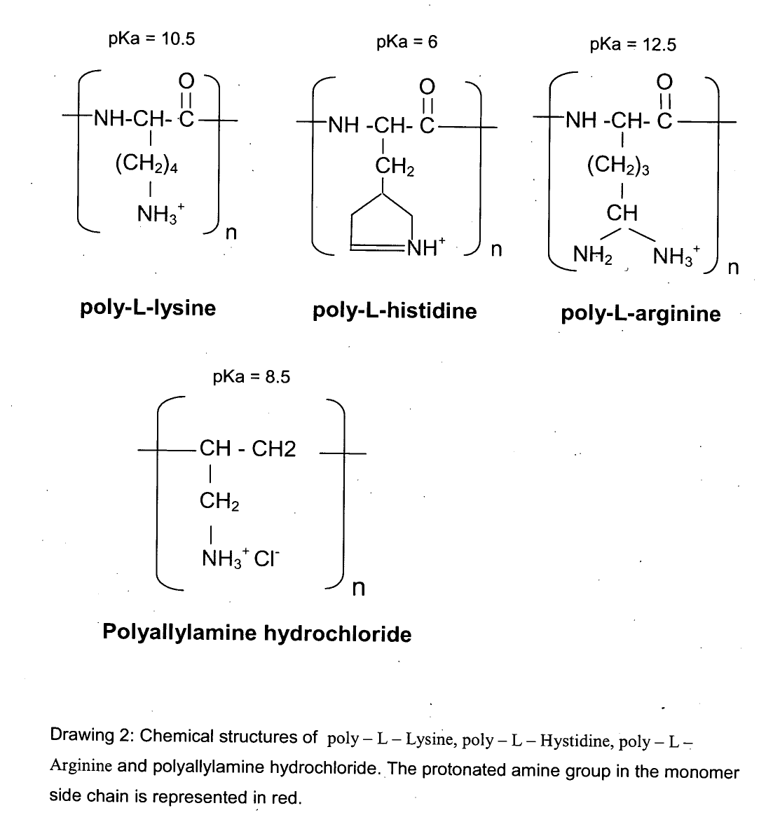

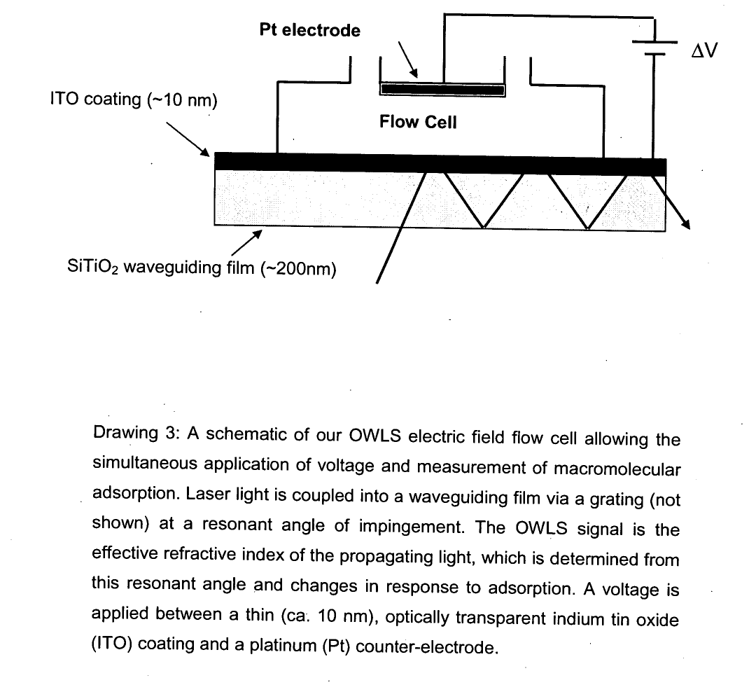

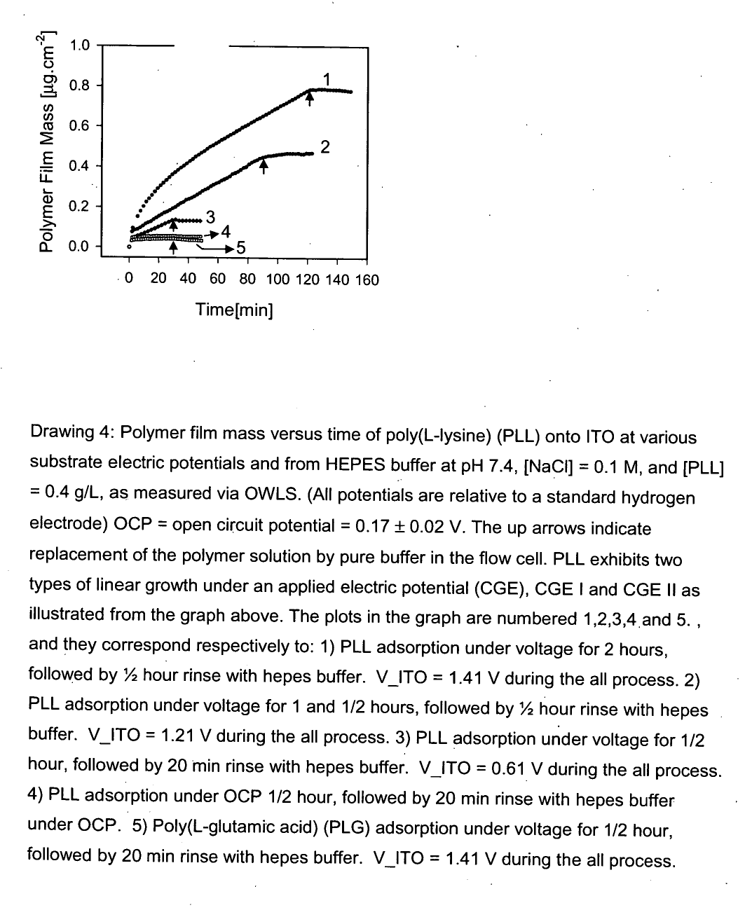

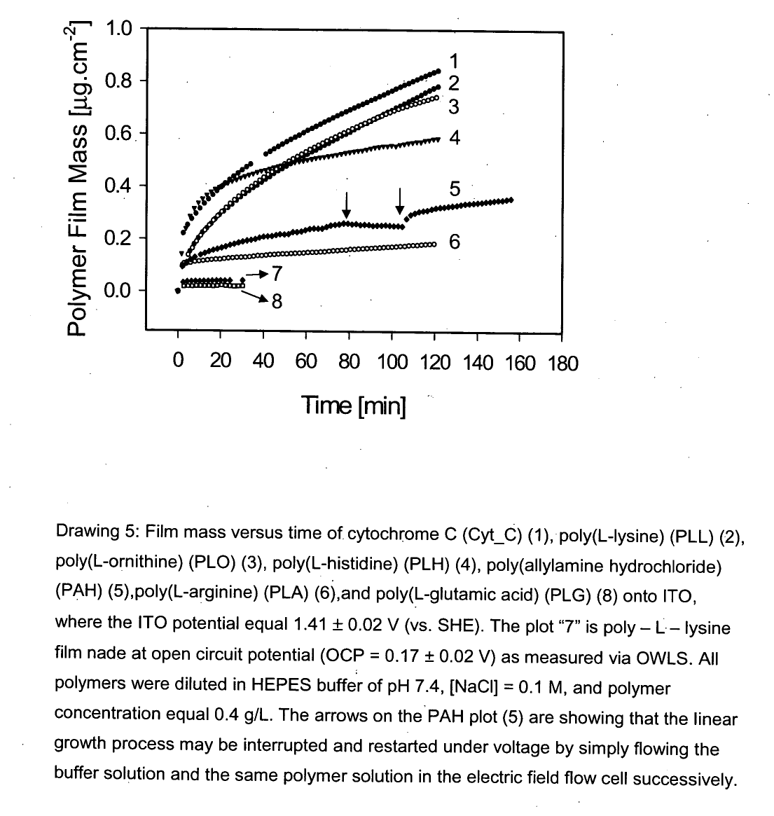

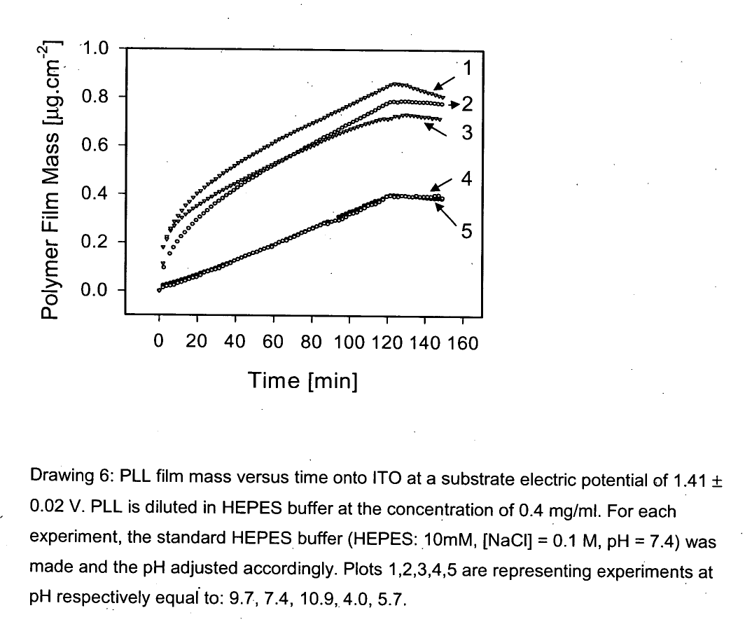

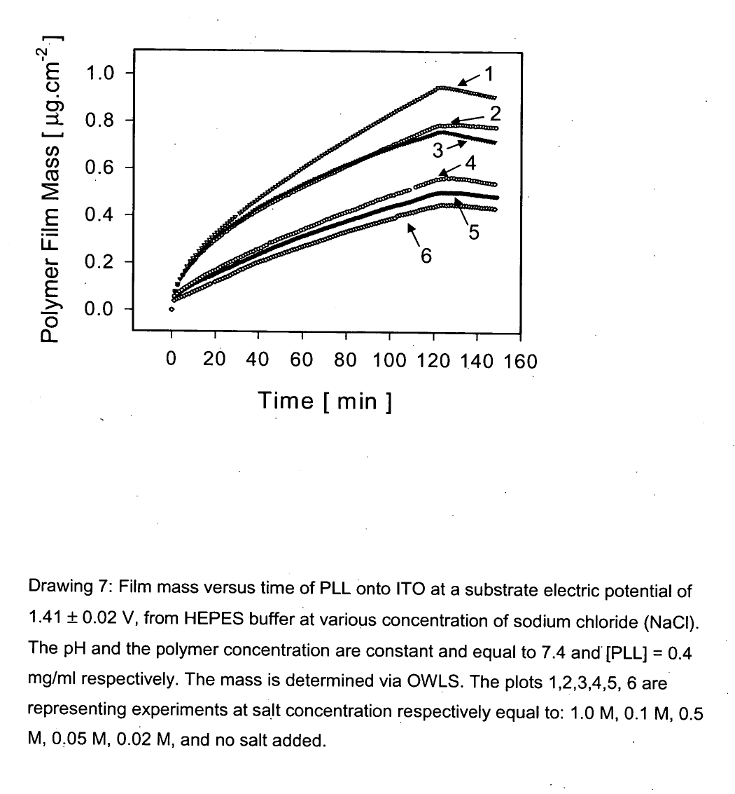

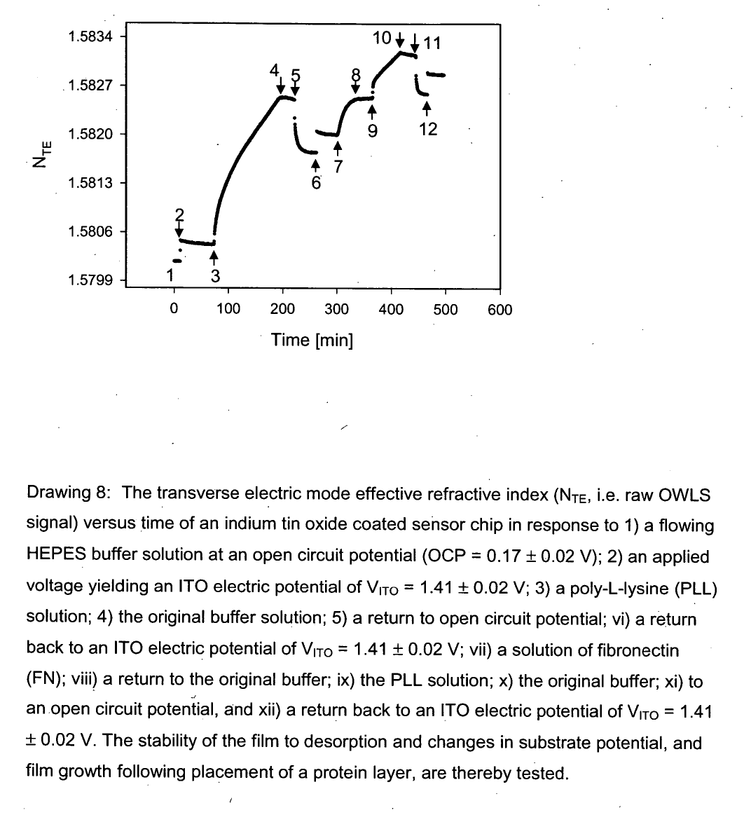

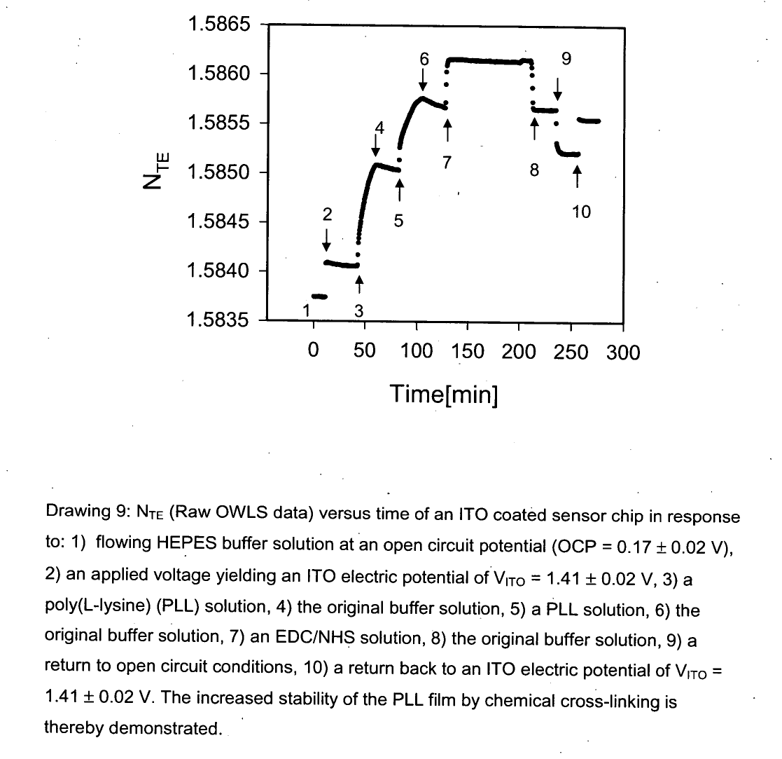

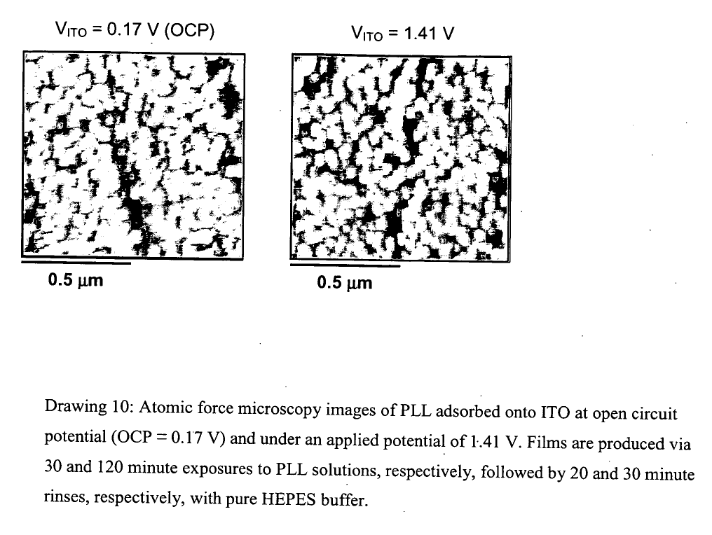

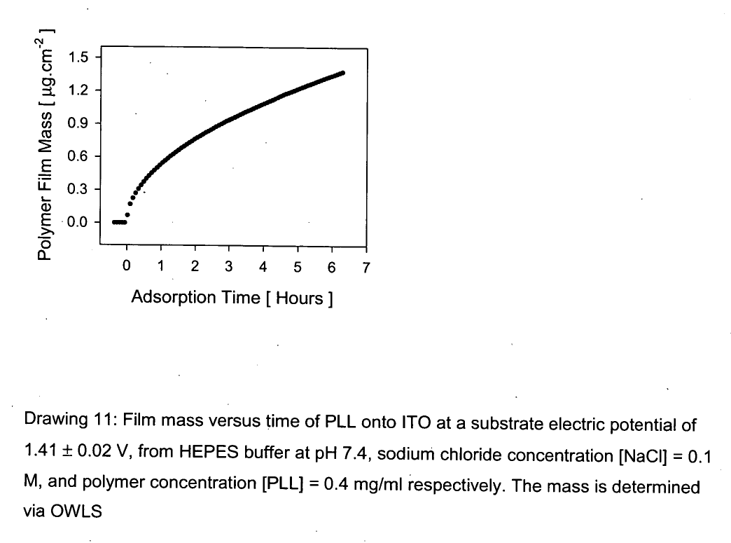

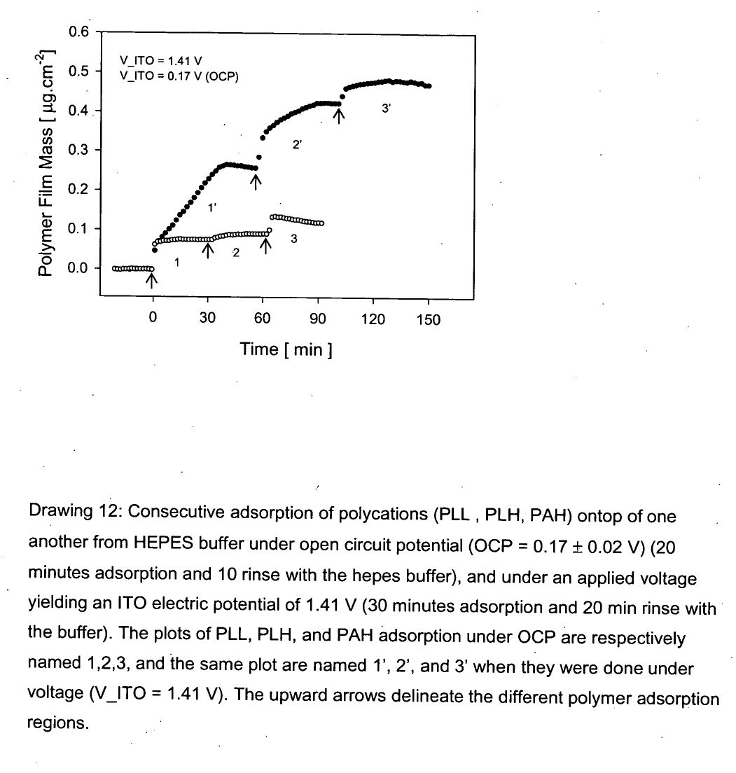

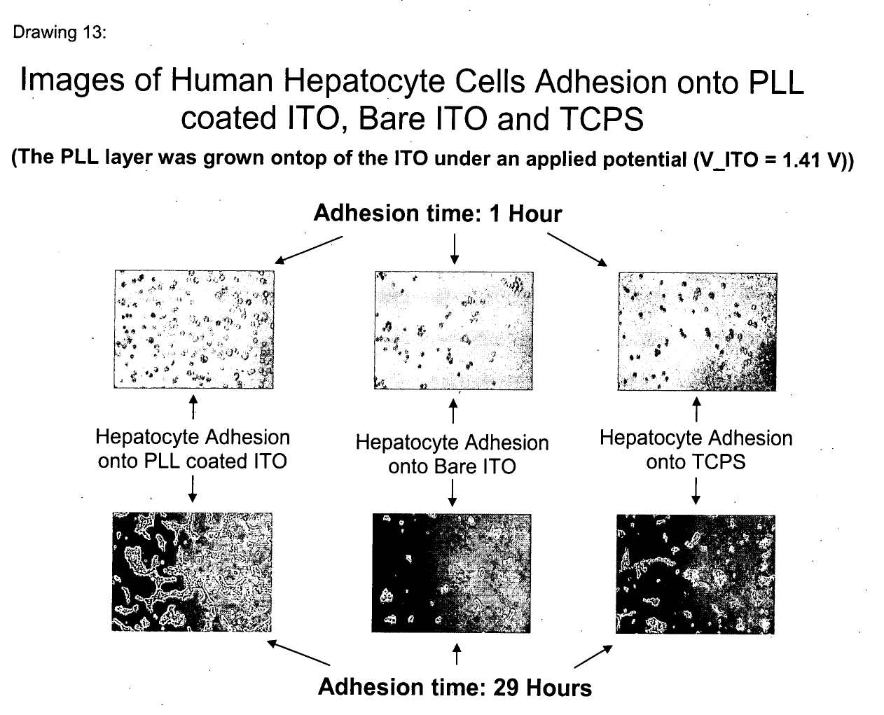

### CROSS-REFERENCE TO RELATED APPLICATIONS

This non-provisional application corresponds to provisional application 60/606,801 filed on Sep. 2, 2004, by the same inventors, under the title “A Polyelectrolyte Thin Film of Controllable Thickness Grown under Voltage in a Single Step”.

### STATEMENT REGARDING FEDERALLY SPONSORED RESEARCH

Work leading to this application was partially funded by the National Institutes of Health under Grant No. R01-EB00258.

### REFERENCE TO SEQUENCE LISTING

Not applicable

### BACKGROUND OF THE INVENTION

Polymers are chain-like molecules composed of individual repeat units (monomers). Thin polymer coatings of thickness 1-100 nm (1 nm=10⁻⁹ m) play crucial roles in many chemical, biological, and biomedical applications. For example, weakly charged colloidal particles may be stabilized through adsorbed polymer layers, and polymer films containing functional entities (e.g. biomolecules, nanoparticles) may serve as sensors, separation agents, and electrochemical components. A number of techniques exist to realize thin polymer coatings, including adsorption from solution, evaporative spin and dip coating, self-assembly, and transfer of films from the liquid/vapor interface (i.e. the Langmuir-Blodget method). Recently, a new Layer-by-Layer (LbL) method has been introduced for growing thin films of charged polymers (polyelectrolytes) [1]. In LbL, a substrate is first exposed to a solution of positively charged polyelectrolyte until a saturated adsorbed layer is realized. The substrate plus initial layer is then exposed to a solution of negatively charged polyelectrolyte, from which adsorption of a second layer occurs. This process continues until a film of desired thickness is obtained. (One could also begin with a negatively charged polymer layer.)

Although the LbL method is becoming widespread, it suffers from two problems: 1) LbL requires a substrate to be exposed two times per added layer (one time with a polymer solution, one time with a polymer free solution as a rinse). Since typical films contain 20 or more layers, many exposures are needed to obtain a useful product. 2) LbL films must be composed of at least two components (the polyanion and the polycation), thus limiting the chemical and physical homogeneity of the film.

In this document, our invention is based on adsorption of charge macromolecules from solutions under an applied electric potential. The influence of an applied electric potential on the adsorption of charged macromolecules has been the subject of several previous investigations [2-23]. Most of these studies attest to the influence substrate potential may have on the adsorption process. However none of the work done describes the mechanism and the properties of polymer nanofilms growth as we did in this report. On the best of our knowledge, this invention is being reported for the first time.

### BRIEF SUMMARY OF THE INVENTION

The present invention consists of a process for growing polymer and protein films onto electrode surfaces from aqueous solutions. In this process, following an initial transient period, the growth is linear in time for an applied anodic potential exceeding a threshold value. (Henceforth we refere to this phenomenon as “continuous growth under an electric potential”, or CGE). The CGE may last for hours. The existence of a linear growth regime allows for films of arbitrary or controllable thickness to be obtained in a single step. CGE as described in this document is specific to weak polycations (i.e, positively charged polyelectrolytes whose charge vary with the polymer solution pH), particularly polymers that contain protonatable (able to be protonated) amine groups in the side chain of their repeating units (monomers). Some examples of such polymers are poly(L-lysine), poly(L-hystidine), poly(L-arginine) and poly(allylamine hydrochloride). CGE allows a high degree of control over the mass and the thickness of the resulting films, in a relatively large range of polymer molecular weight, pH and ionic strength. CGE also allows for the regulation of the overall surface charge density of the film.

### BRIEF DESCRIPTION OF THE DRAWING

Drawing 1: An illustration of the invention: A polymer film forms on the anode under an applied electric potential difference.

Drawing 2: Chemical structures of poly(L-lysine), poly(L-hystidine), poly(L-arginine) and poly(allylamine hydrochloride). The terminating amine group in their side chain is represented in gray.

Drawing 3: Schematic of the OWLS electric field flow cell.

Drawing 4: Poly(L-lysine) (PLL) film growth onto an indium tin oxide substrate, at various electric potentials.

Drawing 5: Evidences of the continuous growth with different polymers.

Drawing 6: Film mass versus time of PLL onto ITO at a substrate electric potential of 1.41±0.02 V, from HEPES buffer at various pHs.

Drawing 7: “PLL films” mass versus time at various concentration of sodium chloride (NaCl). The films are built from PLL solution in HEPES buffer onto ITO substrates under an applied voltage yielding an ITO electric potential of V_{ITO}=1.41±0.02 V)

Drawing 8: A fibronectin layer is embedded in between two PLL layers grown onto ITO substrate under an applied voltage yielding an ITO electric potential of V_{ITO}=1.41±0.02 V.

Drawing 9: A demonstration of the improvement of polymer film stability following a chemical crosslink treatment.

Drawing 10: Contact mode AFM images (in liquid) of PLL layers formed under open circuit potential (OCP=0.17±0.02 V) (30 minutes adsorption and 30 rinse with the hepes buffer), and under an applied voltage yielding an ITO electric potential of 1.41 V (120 minutes adsorption and 30 min rinse with the buffer).

Drawing 11: Long Adsorption Time: Film mass versus time of PLL onto ITO at a substrate electric potential of 1.41±0.02 V for an adsorption time bigger than 6 hours.

Drawing 12: Consecutive adsorption of polycations (PLL PLH, PAH) ontop of one another from HEPES buffer under open circuit potential (OCP=0.17±0.02 V) (20 minutes adsorption and 10 rinse with the hepes buffer), and under an applied voltage yielding an ITO electric potential of 1.41 V (30 minutes adsorption and 20 min rinse with the buffer).

Drawing 13: Images of Hepatocyte Cells Adhesion onto ITO coated with PLL under an applied voltage yielding an ITO electric potential of V_{ITO}=1.41±0.02 V, onto Bare ITO, and the tissue culture polystyrene (TCPS).

### DETAILED DESCRIPTION OF THE INVENTION

The process involves two electrodes in a polymer-containing solution as it is represented on the drawing 1. Application of a potential difference between the electrodes results in polymer film growth onto the anode that, following an initial transient period, is continuous and linear in time for an applied potential exceeding a threshold potential. This process is referred to as continuous growth under an applied electric potential (CGE), which is taken to mean a constant rate of addition of polymer onto an electrode surface in the presence of an applied potential, with the rate being limited by surface effects (i.e. not limited by transport of polymer to the surface from the bulk liquid). Two types of CGE are possible. CGE I consists of growth that is linear in time (i.e. constant rate of growth). CGE II consists of growth that asymptotically approaches the rate of growth of CGE I. These behaviors are demonstrated in Drawing 2. The process is applicable to polymers containing a protonatable amine group in the side chain of their repeating units (monomers). Some examples of such polymers are poly(L-lysine), poly(L-hystidine), poly(L-arginine) and poly(allylamine hydrochloride) (see drawing 2). CGE is also specific to proteins and polypeptides containing a relatively large fraction of monomers carrying a protonatable amine. One example of such protein is “Horse Heart Cytochrome C”. The process is also applicable to any existing polymer which is modified with a protonatable amine attached to the lateral side chain of his monomer

Experimental Procedure

We demonstrate the CGE using optical waveguide lightmode spectroscopy (OWLS), an optical technique that allows to measure the mass of polymer layers at solid/liquid interfaces. Our OWLS instrument (BIOS-1, MicroVacuum, Hungary) is composed of a parallel plate flow cell whose bottom surface is an OW 2400c Sensor Chip (MicroVacuum), consisting of a ca. 10 nm indium tin oxide (ITO or In₂₋₂ₓSnₓO₃₋ₓ with x=0.50±0.02: conductive layer) coating on a planar Si₁₋ₓTiₓO₂ waveguide (x=0.25±0.05), itself coated onto a glass substrate. A flat Pt counter electrode is placed at the top of the flow cell ceiling, parallel to it, at 1.0 mm above the ITO surface. A voltage is applied between the ITO and Pt electrodes using an external power supply and the ITO potential is determined using an electrometer (Model 6514, Keithley, Ohio) in series with a Ag/AgCl reference electrode placed in the inlet solution. All potentials are reported versus a standard hydrogen electrode (SHE). A schematic of our OWLS systems is shown in drawing 3.

OWLS Experiments

Prior to each experiment, the “Electric Field Flow Cell” (EFFC), the tubing and the sensor chip are cleaned by exposure to a 2% Hellmanex (Hellma, Mulheim, Germany) solution in ultrapure water, followed by an intensive rinse with ultrapure water.

The ITO coated sensor chip (see drawing 3) is mounted on the EFFC and is brought in contact with the degassed HEPES buffer solution. The EFFC/sensor chip assembly is then inserted into the head of the OWLS instrument. The sensor chip in contact with buffer is allowed to equilibrate for approximately 3 hours. After the equilibration procedure, two baselines are consecutively monitored at ΔV=0 and ΔV set to the experimental value (ΔV_{Exp}). The adsorption process then consists of introducing the polymer solution or the protein solution [Cytochrome C or fibronectin (FN: used as an example of protein embedded in a polymer layer grown under electric field) into the flow cell by a peristatic pump at a constant flow rate whose corresponding shear rate is 1.5 s⁻¹. The same flow rate is used throughout the experiment.

Typical experiments are done in the following sequences:
1) Hepes buffer is introduced in the flow cell at open circuit potential (OCP) corresponding to ΔV=0 V during ca. 10 min. A baseline is acquire under OCP
2) The voltage value is set at ΔVₑₓₚ. A second baseline is acquire under voltage during ca. 45 min
3) The sample (the polymer solution) is continuously introduce in the flow cell at ΔVₑₓₚ during 30 min or more (Buildup of the polymer or protein layer under voltage)
4) The flow cell is flushed with hepes buffer at ΔVₑₓₚ during 30 min or more (Rinse with the buffer solution after polymer or prorein adsorption under electric field)
5) The flow cell is flushed with hepes buffer at OCP during 30 min or more
6) The flow cell is flushed with hepes buffer at ΔVₑₓₚ during 30 min or more (Test of the layer stability)

The crosslink procedure was performed between steps 4 and 5 by flowing a solution of 200 mM EDC (1-Ethyl-3(Dimethylaminopropyl)Carbodiimide) and 100 mM of NHS (N-Hydroxysulfosuccinimide Sodium Salt) in HEPES buffer in the EFFC for ½ hour. Afterwards, the film and EDC/NHS solution were incubated for 1½ hours, and then rinsed with pure buffer for 20 min. The crosslink procedure allows to covalently link carboxylate and primary amine groups. This procedure follows closely that of Ref. [26].

In certain experiments, following step 6, a FN layer is embedded between two PLL layers. This is done by performing steps 7 and 8 described below, after which steps 3 and 4 are repeated.
7) FN adsorption at ΔVₑₓₚ during ca. 25 min
8) Rinse with buffer solution during ca. 20 min
   Samples Preparation

All chemicals, except NaCl and NHS (obtained from Fluka) were purchased from the Sigma Aldrich Company. Our samples are solutions of poly(L-lysine) (PLL) (MW ca. 70-150 kD) poly(L-ornithine) (PLO) of molecular weight 36.7 kD, poly(L-histidine) (PLH) of molecular weight 5.8 kD, poly(L-arginine) (PLA) of molecular weight 93.8 kD, poly(L-glutamic acid) (PGA) of molecular weight 7.5 kD, poly(allylamine hydrochloride) (PAH) of molecular weight ca. 70 kD, and poly(ethylene imine) (PEI) of molecular weight 70 kD. All polymers and proteins were dissolved in hepes buffer at the concentration of 0.4 mg/ml, except human plasma fibronectin (FN, MW ca. 550 kD, pl 5.5-6.3, 0.1% solution in 0.05 M Tris buffered saline at pH 7.5) dissolved in HEPES buffer at a concentration of 50 μg/ml. HEPES buffer is made from 10 mM N-(2-hydroxyethyl)piperazine-N′-2-ethanesulfonic acid, 100 mM NaCl, and deionized water (of conductivity 1.30±0.05 μS and pH 5.5-6). During the buffer preparation, the final pH is adjusted to 7.4 by adding a few drops of 6 N NaOH. Prior to use, the buffer is degassed in an ultrasonic bath for 30 minutes and filtered (Millipore filter, 0.4 μm). For experiments performed at PHs higher or lower than 7.4, the initial pH of the buffer is adjusted accordingly, using few drop of NaOH 6N or HCl 6N.

Experimental Demonstration of CGE

In Drawing 4, an OWLS measurement is shown of poly(L-lysine) (PLL) film growth onto an indium tin oxide substrate, at various electric potentials. Under open circuit potential (OCP=0.17±0.02 V, relative to the standard hydrogen electrode) (Plot 4 in the graph), saturation occurs quite rapidly, within a few minutes. For substrate electric potentials within the range of 0.6 to 1.2 V (Plots 2 and 3), rapid initial film growth occurs up to approximately the OCP saturation level, followed by a linear growth regime. This behavior is referred to as “CGE I”. For a higher potential (Plot 1), the rapid initial growth persists for a longer time period, resulting in a thicker film. Following this initial period, an extended growth regime persists for several hours and no saturation is observed. This behavior is referred to as “CGE II”. No appreciable detachment of polymer occurs upon replacing the polymer solution with a pure buffer (i.e. an otherwise identical solution without polymer). Film mass versus time for poly(L-glutamic acid) onto ITO at V_{ITO}=1.41 V is shown as a control (i.e. no linear growth) (Plot 5).

In Drawing 5, OWLS measurements of films composed of several other polymers and cytochrome C are shown, at a substrate potential of 1.41±0.02 V.

In these experiments, all polymers that are carrying a protonable amine in their lateral side chain (PLL, PLO, PLA, PLH, PAH) are weak polycation around pH=7. They all exhibit a linear growth behavior under voltage. As a control, poly(L-glutamic acid), a polyanion, exhibits no linear growth regime and instead reaches a rapid saturation.

Cytochrome C is a protein composed of 104 amino acids. Among them, 19 are lysine, 3 hystidine and 2 arginine. The pKa of cytochrome C is 9.4. It's therefore not surprising that cytochrome C would behave like a weak polycation, and therefore, will exhibit CGE under an applied electric potential.

Effect of pH on the Linear Growth of poly(L-I-ysine)

In Drawing 6, OWLS measurements are shown of PLL film growth, from solutions of various pH values, for a substrate potential of 1.41±0.02 V. The pH of HEPES is altered by the addition of HCl or NaOH.) Increasing pH from 7.4 Over a range of pH values, CGE I and CGE II behaviors are observed. Below pH 4.0, no film growth occurs, probably due to a positive ITO surface charge.

Effect of the Polymer Solution Salt Concentration

In Drawing 7, OWLS measurements are shown of PLL film growth, from solutions of various NaCl concentrations. Over a range of [NaCl] from 0 M to 1 M, CGE I and CGE II behaviors are observed.

In Drawing 8, the stability of the PLL layer to removal of the applied potential difference is demonstrated. For a PLL film formed at ITO substrate potential V_{ITO}=1.41±0.02 V and pH 7.4, switching to an open circuit potential results in a decrease in signal (proportional to film mass per area). A decrease is expected owing to the direct influence of substrate potential on signal. In order to distinguish this contribution from changes in the adsorbed layer, a return to V_{ITO}=1.41±0.02 V is conducted and the signal increases nearly to its value prior to the removal of the potential. The PLL layer is thus fairly stable to removal of the applied electric potential.

In Drawing 9, the possibility to continue CGE following placement of a layer of protein is demonstrated. Following adsorption of protein to the surface of a CGE film composed of PLL, introduction of a PLL solution results in further CGE.

The stability of the adsorbed polyelectrolyte layers may be further enhanced via chemical cross-linking. In Drawing 9, an OWLS measurement is shown of i) PLL film at V_{ITO}=1.41±0.02 V, and ii) the chemical cross-linking of the film using a HEPES solution containing EDC/NHS chemical cross-linking agents, 0.05 M N-hydroxysuccinimide (NHS) and 0.2 M N-ethyl-N′-dimethylaminopropylcarbodiimide (EDC). The cross-links formed in this way are amide bonds between amine groups (from the side chains or N terminus of PLL) and carboxyl groups (from the PLL C terminus). Despite the relative paucity of the latter, the cross-linked film is stable to removal of the applied electric potential.

Film Characteristic and Properties

AFM Images of PLL Films

AFM images are collected in contact mode using an ESPM Atomic Force Microscope equipped with a 20 μm Dual PZT scanner (Novascan Technologies, Ames, Iowa) and a silicon nitride cantilever (Model DNP-S, manufactured by Veeco; Spring constant: 0.06 N/m) equipped with a sharpened tip (height: 2.5 □m-3.5 □m; radius: ca. 30 nm). Samples are realized via the aforementioned OWLS experiment. During the transfer of the OWLS sensor chip to the AFM system, all samples are kept in contact with the buffer solution in order to avoid contact with air.

In Drawing 10, we show contact mode AFM images (in liquid) of PLL layers formed under OCP (30 minutes adsorption and 20 of rinse with the hepes buffer), and under an applied potential of 1.41 V (120 minutes adsorption and 30 min rinse with the buffer). Both images show uniformly distributed particles in close contact with one another. Particle diameters range from 50 to 70 nm and 70 to 90 nm, and root mean square roughness values are 3.7±0.1 nm and 3.0±0.1 nm, at 1.41 V and 0.17 V (OCP), respectively.

Direct Evidences of the Deprotonation in the Polymer Films Built under Voltage: XPS Measurement

The direct evidence of the loss of the charges in the polymer film is demonstrated by an XPS measurement performed on different samples of PLL films made at OCP and at 1.41 V. The results of these measurements are shown in Table I. These data show the percentage of charged side chains (—NH₃⁺ terminated) to decrease approximately from 30% to 16% in the presence of the applied potential.

TABLE I
XPS Analysis of the PLL films grown under 1) open circuit potential
(OCP = 0.17 ± 0.02 V) and 2) an applied voltage yielding an
ITO electric potential of V_{ITO} = 1.41 ± 0.02 V; 3)

| | | |
|---|---|---|
| Species | B.E. (eV) | % |

Sample: PLL layer built under OCP

| | | | | |
|---|---|---|---|---|
| Spot 1 | N1s | amide/NH2 | 399.9 | 70.8 |
| | | NH₃⁺ | 402.1 | 29.2 |
| Spot 2 | N1s | amide/NH2 | 399.8 | 69.1 |
| | | NH₃⁺ | 401.9 | 30.9 |

Sample: PLL layer built under voltage, V_ITO = 1.41 V

| | | | | |
|---|---|---|---|---|
| Spot 1 | N1s | amide/NH2 | 399.9 | 81.9 |
| | | NH₃⁺ | 401.8 | 18.1 |
| Spot 1 | N1s | amide/NH2 | 399.9 | 85.7 |
| | | NH₃⁺ | 401.6 | 14.3 |

Indirect Evidence of the Deprotonation of the Polymer Films Built under Voltage: Hydrophobicity
Contact Angle Measurement

An indirect evidence of deprotonation within the film is given by a contact angle measurement performed on samples built under OCP and under an applied potential (and subsequently returned to OCP following film formation). The contact angles for PLL, PLH, PGA, PAH, and Cyt_C, as determined using a NRL C. A. Goniometer, model 100-00-115 (rame-hart, Inc., New Jersey, USA) apparatus, tend to increase under increasing potential (see Table II below: Contact Angle Measurements). An increased contact angle is direct evidence of increased hydrophobicity and indirect evidence of decreased charge within the polymer film.

TABLE II
Contact Angles Measurements:

| | | Contact Angle |
|---|---|---|
| | Contact Angle of | of the Film |
| | the Film | Built under Voltage |
| | Built under OCP | (V_ITO = 1.41 V) |
| Poly-L-Lysine | 37 ± 1 | 50 ± 1 |
| Poly-L-Hystidine | 37 ± 1 | 47 ± 1 |
| Poly-L-Arginine | 32 ± 1 | 51 ± 1 |
| polyallylamine Hydrochloride | 27 ± 1 | 40 ± 1 |
| Horse Heart Cytochrome C | 31 ± 1 | 54 ± 1 |

Mechanism of the Continuous Growth

Assuming a polylysine (PLL) solution at pH=7.4, the adsorption of PLL on bare ITO surface at open circuit potential (OCP) does not show any linear growth due to the reversal of the surface charge upon PLL adsorption. At a this pH, PLL is positively charge, and following the initial adsorption step, the surface saturation is quickly reach due to strong repulsion between bulk PLL and those already adsorbed on the surface.

Above the threshold potential where the continuous growth under an electric potential (CGE) happens, the mechanism of the CGE is thought to involve initial attachment of the polymer chains in a highly charged state and subsequent loss of charges, as influenced by the applied potential upon growth reaching a critical film mass density. The loss of charge is mainly the deprotonation of the adsorbed polycations on the surface. The subsequent film growth is driven by enhanced secondary (hydrogen bonding and van der waals) interactions between bulk and surface adsorbed polymers.

Human Hepatocite Cells Adhesion and Growth onto Polymer Films Grown under an Applied Potential

In this paragraph, we demonstrate the interaction of a polymer layer grown under an applied potential with living cells. To achieve this goal, a polylysine (PLL) layer was grown under an applied electric potential onto ITO substrate (PLL coated ITO) at V_ITO=1.41 V using the OWLS instrument as it is described in the “EXPERIMENTAL PROCEDURE” (PAGE 5 of this document). The coated ITO was then put in contact with cells and pictures of the cells are made after hours.

The cell culture medium was prepared by adding 5 ml of penicillin and streptomicyn, 5 ml of glutamine and 50 ml of fetal bovine serum to 500 ml Dulbecco's Modified Eagle Medium (DMEM). Hepatocyte from a cell line was added to the culture medium at the final concentration of 1.4×10⁵ cells per ml. 10 ml of the cells/medium solution was put in an empty Petri dish and the PLL coated ITO was soaked in the final solution (sample). The prepared sample was put in the incubator where the temperature was set at 37° C. and the humidity properly controlled. Images of the cells attached to the “PLL coated ITO” were captured after short (−1 hours) and long time (˜1 day) contact.

From the pictures on the drawing 11, we can see that after 1 hour adhesion, the quantity of hepatocyte cells that are attached are higher on the PLL coated ITO, compare to the bare ITO and the tissue culture polystyrene (TCPS). This is clearly demonstrate that the hepatocyte cells have higher affinity with the PLL coated ITO surface. Moreover, the images taken after 29 hours are showing that the hepatocyte cells are able to spread and growth on the PLL coated ITO.

These experiments are showing that, polymer layers grown under an applied potential are potentially good candidates for the tissue engineering applications.

### REFERENCES

1. G. Decher, Science 277, 5330 (1997)
2. Morrissey, B. W., Smith, L. E., Stromberg, R. R. & Fenstermaker, C. A. (1976) Journal of Colloid and Interface Science 56, 557-563.
3. Kawaguchi, M., Hayashi, K. & Takahashi, A. (1988) Colloids and Surfaces 31, 73-88.
4. Kawaguchi, M., Hayashi, K. & Takahashi, A. (1988) Macromolecules 21, 1016-1020.
5. Beaglehole, D., Webster, B. & Werner, S. (1998) Journal of Colloid and Interface Science 202, 541-550.
6. Holmstrom, N., Askendal, A. & Tengvall, P. (1998)Colloids and Surfaces B-Biointerfaces 11, 265-271.
7. Bernabeu, P. & Caprani, A. (1990) Biomaterials 11, 258-264.
8. Fraaije, J., Kleijn, J. M., Vandergraaf, M. & Dijt, J. C. (1990) Biophysical Journal 57, 965-975.
9. Feng, L. & Andrade, J. D. (1994) Journal of Colloid and Interface Science 166, 419-426.
10. Khan, G. F. & Wernet, W. (1997) Thin Solid Films 300, 265-271.
11. Asanov, A. N., DeLucas, L. J., Oldham, P. B. & Wilson, W. W. (1997) Journal of Colloid and Interface Science 191, 222-235.
12. Asanov, A. N., Wilson, W. W. & Odham, P. B. (1998) Analytical Chemistry 70, 1156-1163.
13. Fievet, P., Mullet, M., Reggiani, J. C. & Pagetti, J. (1998) Colloids and Surfaces a-Physicochemical and Engineering Aspects 144, 35-42.
14. Brusatori, M. A. & Van Tassel, P. R. (2003) Biosensors & Bioelectronics 18, 1269-1277.
15. Brusatori, M. A., Tie, Y. & Van Tassel, P. R. (2003) Langmuir 19, 5089-5097.
16. Bearinger, J. P., Voros, J., Hubbell, J. A. & Textor, M. (2003) Biotechnology and Bioengineering 82, 465-473.
17. Barten, D., Kleijn, J. M. & Cohen Stuart, M. A. (2003) Physical Chemistry Chemical Physics 5, 4258-4264.
18. Moulton, S. E., Barisci, J. N., Bath, A., Stella, R. & Wallace, G. G. (2003) Journal of Colloid and Interface Science 261, 312-319.
19. Fang, F. & Szleifer, I. (2003) Journal of Chemical Physics 119, 1053-1065.
20. Gong, P. & Szleifer, I. (2004) Journal of Colloid and Interface Science 278, 81-90.
21. Kleijn, J. M., Barten, D. & Cohen Stuart, M. A. (2004) Langmuir 20, 9703-9713.
22. Moulton, S. E., Barisci, J. N., Bath, A., Stella, R. & Wallace, G. G. (2005) Langmuir 21, 316-322.
23. Ngankam, A. P. & Van Tassel, P. R. (2005) Langmuir 21, 5865-5871.

1. A process for growing polymer films onto an electrode surface from a polymer-containing solution. The main characteristic of this process is that the polymer film grows linearly (continuous growth under an electric potential, or CGE) in time for an applied anodic potential exceeding a threshold potential following an initial transient period. The linear growth regime may last for many hours and allows films or arbitrary and controlable thickness and mass to be built in a single step. The process is applicable to weak polycations (i.e positively charged polymers whose charge vary with the pH of the solution), particularly to polymers that contain a protonatable amine group in the side chain of their repeating units (monomers). Some examples of such polymers are poly(L-lysine), poly(L-hystidine), poly(L-arginine) and poly(allylamine hydrochloride). CGE is also specific to proteins and polypeptides containing a relatively large fraction of amino acids carrying a protonatable amine in their side chain. The process is also applicable to any existing polymer which has been modified in such a way that a protonatable amine be attached to the side chain of his monomer, the resulting polymer being a weak polycation. The linear growth process takes place in a wide range of the pH and salt concentration of the polymer solution.

2. A film obtainable by a process as claimed in claim #1.

3. The process as claimed in claim #1 and the resulting film, wherein mixtures of polycations are employed.

4. The process as claimed in claim #1 and the resulting film, wherein different polycations are introduced sequentially.

5. The process as claimed in claim #1, wherein other macromolecular (polymer, protein, etc.) or particulate (nanoparticle, colloidal particle, cell, etc.) entities are introduced during pauses in CGE.

6. A polymer film obtainable by a process as claimed in claim #5.

7. The process as claimed in claim #1, wherein other macromolecular (polymer, protein, etc.) or particulate (nanoparticle, colloidal particle, cell, etc.) entities are introduced during pauses in CGE.

8. A polymer film obtainable by a process as claimed in claim #7.

9. The process as claimed in claim #7, wherein one or more pharmaceutical agents are introduced during pauses in CGE.

10. The process as claimed in claim #1, wherein CGE occurs onto a template layer previously deposited onto the electrode surface.

11. The process as claimed in claim #1, wherein living cells are grown on top of the film.

12. A film obtainable by a process as claimed in claim #11.

13. A process as claimed in claim #2, wherein the film's percentage of protonated amine groups is reduced in comparison with the same film built without a an applied potential (open circuit potential).

14. A method as claimed in claim #13, wherein films of relatively high hydrophobicity are generated.

15. A method as claimed in claim #1 and the resulting film, wherein the polymer used was previously modified by attaching a protonatable amine to the side chain of his monomer.

17. A method for inducing the deprotonation within polymer or protein films at solid/liquid interfaces, wherein the film is previously adsorbed onto a conductive substrate followed by application of an electric potential between the substrate and a counter electrode.

18. A film obtainable by a process as claimed in claim #17.

19. A method as claimed in claim #17, wherein films of relatively high hydrophobicity are generated.

20. A method as claimed in claim #17, wherein the film is composed of one or many macromolecular (polymer, protein, etc.) or particulate (nanoparticle, colloidal particle, cell, etc.) entities.
